(19) United States
(12) Patent Application Publication
(10) Pub. No.: US 2010/0237983 A1
(43) Pub. Date: Sep. 23, 2010

(54) SYSTEM AND METHOD FOR USING CONCEALED INFRARED IDENTIFIERS TO CONTROL MOTION-DETECTING SOCIAL COMPUTING DEVICES

(75) Inventors: Gavan L. Tredoux, Penfield, NY (US); Michael R. Campanelli, Webster, NY (US); Edward N. Chapman, Rochester, NY (US); Jeffrey D. Kingsley, Macedon, NY (US)

Correspondence Address: Gibb Intellectual Property Law Firm, LLC;Frederick W. Gibb, III, Esq., 844 West Street, Suite 100, Annapolis, MD, 21401, US

(73) Assignee: XEROX CORPORATION, Norwalk, CT (US)

(21) Appl. No.: 12/408,064

(22) Filed: Mar. 20, 2009

(51) Int. Cl. G05B 19/00; G06K 7/10; G06F 17/00

(52) U.S. Cl. 340/5.1; 235/468; 235/375

(57) ABSTRACT

A processor receives infrared inputs from at least one sensor when an item is placed upon a user interface detectable by the sensor. The processor evaluates the infrared inputs to identify an infrared-printed content printed on the item. The processor retrieves an electronic representation related to the item from at least one computer storage device based on the infrared-printed content and displays the electronic representation related to the item on the user interface.

### BACKGROUND AND SUMMARY

Embodiments herein generally relate to electrostatic printers and copiers or reproduction machines, and more particularly, concerns a method and system that can print infrared content code on items and scan such infrared code from items and allow such scanned items to appear within and be manipulated by a graphic user interface.

Associating digital identifiers with objects, such as documents, is useful for facilitating passage between the digital and physical realms. In many applications it is desirable that these identifiers should not be visible to the naked eye, since they may confuse the reader, detract from the physical attractiveness of the object, or interfere with a desired suspension of disbelief. It is also easier to tamper with visible identifiers. Social computing systems that attempt to link the physical and digital realms may benefit especially from a convenient method for hiding identifiers within an object, as this is an efficient method of providing digital information, which is difficult to do in systems that eschew traditional computer keyboards.

Social computing devices, which are constructed to be used by multiple users simultaneously, may use infrared cameras to detect motion and shapes of fingers and other objects. One exemplary social computing device is discussed in detail in U.S. Patent Publication Number 2008/0198138 (the complete disclosure of which is incorporated herein by reference) and the details of such devices are not repeated herein so as to focus the reader on the salient aspects of the present embodiments.

With embodiments herein, the same infrared cameras that detect motion or capture images are used to detect metadata concealed within or on a physical object, such as a document, which is not ordinarily visible to the naked eye. Thus, the embodiments herein build integrated systems in which physical objects can pass digital information to the social computing device, through use of the concealed object metadata in infrared printed form.

Embodiments herein include a machine-implemented method that prints, using an infrared printer, infrared code on an item. The method uses one or more sensor to detect the infrared code printed on the item when the item is placed upon a user interface that is positioned within a detectable range of the sensor. A processor receives the infrared inputs from the sensors and evaluates the infrared inputs to identify the infrared-printed content that was printed on the item. Then, the processor can retrieve an electronic representation related to the item from one or more computer storage devices based on the infrared-printed content. Once retrieved, the processor can display the electronic version or representation related to the item on the user interface to allow the electronic representation related to the item to be observed and manipulated by the user of the user interface. However, the electronic version does not need to be displayed. From detected infrared content, an action could be taken by the device that involved no display or interaction whatsoever. In addition, any item displayed does not have to be the electronic version identified by the infrared content. It is possible that the infrared content could be search instructions that do something totally different, e.g., find similar content like a search for images. Thus, the electronic representation could be search results returned to the user.

System embodiments herein include a user interface that comprises at least a display. The display can comprise a touch screen display and/or can be accompanied by various other input devices such as keyboards, pointing devices, buttons, etc. In one embodiment, the display can comprise the only form of user interface and can be, for example, a virtual table, or surface.

Such systems also include a processor operatively connected to the user interface and one or more sensors operatively connected to the processor and being positioned to sense items physically on the interface. One or more computer storage devices and infrared printers can also be operatively connected to the processor. The computer storage devices can comprise any form of data storage medium, including magnetic storage mediums, optical storage mediums, electronic storage mediums, etc. The infrared printers can comprise any form of printer, including ink-jet printers, electrostatic printers, thermal printers, etc. These items can be directly connected to the processor or can be remote from the processor and can be connected to the processor by way of various networks or other communication means.

The processor stores, within the computer storage device(s) identifications of items as infrared-printed contents are printed on the items by the infrared printer. The processor receives infrared inputs from the sensor when such an item having the infrared-printed contents is placed on or is held near the user interface. The processor evaluates the infrared inputs received from the sensors to identify the infrared-printed content that has been printed on the item. The processor retrieves an electronic representation related to the item from the one or more computer storage devices based on the infrared-printed content and displays the electronic representation related to the item on the user interface to allow the user to view and manipulate the electronic representation related to the item.

The infrared-printed content identifies the name of the item and the computer storage device location of the electronic representation related to the item. The infrared-printed content is detectable only by devices capable of reading light within the infrared portion of the electromagnetic spectrum and cannot be seen with the naked human eye. The items can comprise almost any physical item capable of being manipulated by a user, and can include documents, security cards, souvenirs, keys, toys, pictures, tools, compact discs (CDs), digital video discs (DVDs), floppy diskettes, folders, paper clips, cell phones, personal digital assistants (PDAs), etc.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic diagram of a system embodiment herein that identifies infrared codes on items placed near or on a user interface;

FIG. 2 is a flowchart illustrating various embodiments herein;

FIG. 3A is a picture containing concealed infrared identifiers;

FIG. 3B is the picture shown in FIG. 3A showing the concealed infrared identifiers;

FIG. 4A is a picture containing concealed infrared identifiers; and

FIG. 4B is the picture shown in FIG. 3A showing the concealed infrared identifiers.

### DETAILED DESCRIPTION

Social computing devices are constructed to be used by more than one user simultaneously. They may take the form of a table around which users sit and interact with the device, but other forms are possible, e.g. an upright circular device, or one which hangs on a wall. One way of enabling user interaction with such devices is to detect the movement of body parts such as fingers using cameras capable of detecting infrared. The same cameras are used by the embodiments herein to detect inanimate objects such as mobile devices, books, documents and the like, which may be placed on or around the social computing device.

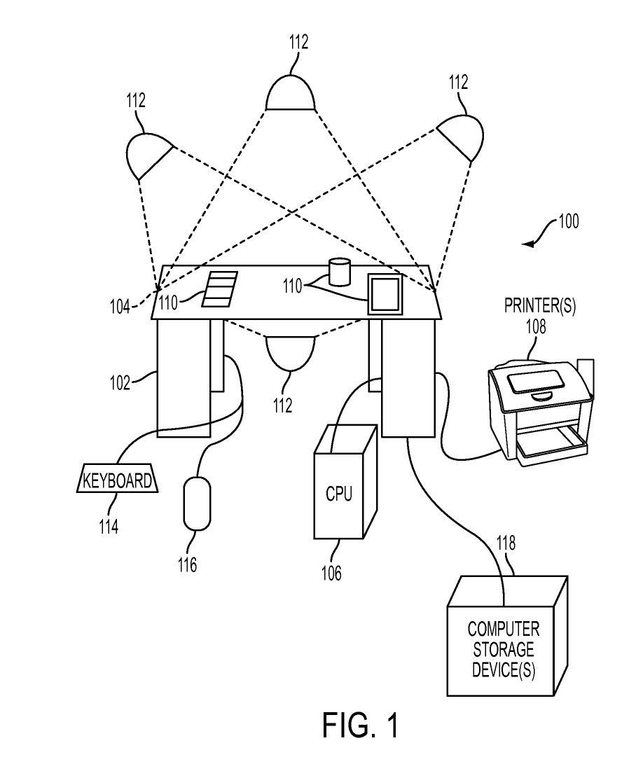

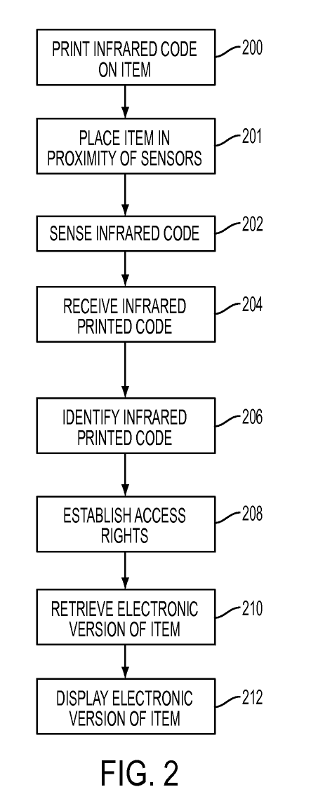

For example, as shown in FIG. 1, one exemplary system embodiment herein include a user interface device 102 (such as an interface table) that comprises at least a display 104 (such as a tabletop display). Various items 110 are shown in FIG. 2 as having been placed upon the display 104. The display 104 can comprise a touch screen display and/or can be accompanied by various other input devices such as keyboards 114, pointing devices 116, buttons, etc. In one embodiment, the display 104 can comprise the only form of user interface and can be, for example, a virtual table, or surface.

One of the features of such social computing devices (such as the user interface device 102 shown in FIG. 1) is that they have the ability to scan items that are placed on the display 104 and to interpret movement of users or the items. Such systems also include a processor 106 (such as a standard computer or computing device) operatively connected to the user interface 102 and one or more sensors 112 operatively connected to the processor 106 and being positioned to sense items 110 physically on the interface.

To sense objects placed on the display screen 104, the sensors 112 capture an image of the display screen 104, and provide the image to the processor 106 for the detection of objects appearing in the image. Sensors 112 may include any suitable image sensing mechanism, such as a charge-coupled device (CCD) array and complementary metal oxide semiconductor (CMOS) image sensors. As illustrated in FIG. 1, the sensors 112 can be above or below the display screen 104. Further, the image sensing mechanisms may capture images of the display screen 104 at a sufficient frequency to detect motion of an object across display screen 104. The display screen 104 may alternatively or further include an optional capacitive, resistive, or other electromagnetic touch-sensing mechanism. Sensors 112 may be configured to detect reflected or emitted energy of any suitable wavelength, including but not limited to infrared and visible wavelengths.

One or more computer storage devices 118 and infrared printers 108 can also be operatively connected to the processor 106. While only one of each is shown in the drawings, one ordinarily skilled in the art would understand that the drawings represent one or more of such devices.

The computer storage devices 118 can comprise any form of data storage medium, including magnetic storage mediums, optical storage mediums, electronic storage mediums, etc. The infrared printers 108 can comprise any form of standard printer, including ink-jet printers, electrostatic printers, thermal printers, etc. that have the ability to use special infrared inks. Thus, while the term infrared printers is used herein, such printers are substantially the same as conventional printers; however, infrared printers use carbon-based toner or ink. In addition, such infrared printers include special software instructions and perform special image processing to hide the infrared identifiers, even though the printing is being performed using an ordinary printing process. Details regarding printers that can create markings that are all detectable in the infrared wavelength spectrum are discussed in, for example, U.S. Patent Publication Number 2008/0302263, the complete disclosure of which is incorporated herein by reference. The details of such printers are not discussed in herein.

Further, while such infrared markings are thought of as being visible only in the infrared spectrum, it is actually what an infrared camera cannot see that allows it to distinguish the infrared printing. In actuality, the infrared printing is hidden from humans by all the other markings that make up the picture; however, the infrared cameras cannot see all the markings that the human eye can see, allowing the infrared cameras to detect the infrared-printed markings. In effect, this restricted spectrum of the infrared cameras unmasks the infrared markings.

These items 110 can be directly connected to (or internal within) the processor 106 or can be remote from the processor 106 and can be connected to the processor 106 by way of various networks or other communication means. For example, the infrared printer 108 would typically be used by a third party (manufacturer of tourist mementos, printer of brochures, etc.) and not connected to the processor 106; however, the infrared printer 108 could be connected to the processor 106, as shown in the drawings.

The processor 106 stores, within the computer storage device(s) 118 identifications of items 110 as infrared-printed contents are printed on the items 110 by the infrared printer(s) 108. More specifically, a user (or a vendor) can upload one or more items (pictures, documents, music, video, etc.) to a network accessible storage location. The user can input the address of the network accessible storage location, along with an identification of the item that will be associated with this data, to the interface device 102 (or this action can be performed automatically). Then, the user can print the infrared code on the corresponding item (or the infrared code can be printed on a sheet that can be affixed to, or transferred to the corresponding item). Thereafter, whenever the infrared code is recognized by the interface device 102, it will access the uploaded data that is maintained at the network accessible storage location.

The processor 106 receives infrared inputs from the sensor(s) 112 when such an item 110 having the infrared-printed contents is later placed on or is held near the user interface 102 display surface 104. For example, the dashed lines shown adjacent the sensors 112 in FIG. 2 illustrate the detectable range of the sensor and illustrate that the sensors 112 would detect the infrared-printed content on any of the items 110 placed on the display surface 104.

The processor 106 evaluates the infrared inputs received from the sensors 112 to identify the infrared-printed content that has been printed on the item 110. The processor 106 retrieves an electronic representation related to the item 110 from the one or more computer storage devices 118 based on the infrared-printed content and displays the electronic representation related to the item 110 on the user interface device 102 to allow the user to view and manipulate the electronic representation related to the item 110.

The infrared-printed content identifies the name of the item 110 and the computer storage device location of the electronic representation related to the item 110. The infrared-printed content is detectable only by devices capable of reading light within the infrared portion of the electromagnetic spectrum and cannot be seen with the naked human eye. The items 110 can comprise almost any physical item capable of being manipulated by a user, and can include documents, security cards, souvenirs, keys, toys, pictures, tools, CDs, DVD, floppy diskettes, folders, paper clips, cell phones, PDAs, etc.

FIG. 2 illustrates the machine-implemented method in flowchart form. More specifically, in item 200, the method prints, using an infrared printer, infrared code on an item. In item 201, the item is placed in proximity of the sensors. The method uses one or more sensor to detect the infrared code printed on the item when the item is placed upon a user interface that is positioned within a detectable range of the sensor in item 202.

The processor receives the infrared inputs from the sensors in item 204 and evaluates the infrared inputs to identify the infrared-printed content that was printed on the item in item 206. If the infrared-printed content contained security information, it could be used to establish access rights to the information maintained within the computer storage devices in item 208. Therefore, for example, before a user might be allowed to access information contained within various databases through the interface device 102, they would first have to present a security card, a physical key, document, or some other form of security device that contains the proper infrared-printed content to the display 104.

Then, the processor can retrieve an electronic representation related to the item from one or more computer storage devices based on the infrared-printed content in item 210. Once retrieved, the processor displays the electronic representation related to the item on the user interface in item 212 to allow the electronic representation related to the item to be observed and manipulated by the user through the user interface.

While the infrared-printed content may be used to take physical items from the real world into the virtual world and may be used to grant security access, the infrared-printed content may also be utilized simply to identify where individuals are positioned with respect to the display 104. For example, the embodiments herein can identify an infrared-printed content on a personal item such as a folder, coffee cup, PDA, etc.) as being owned by a specific individual to identify wherein that individual is seated next to the display 104. With such information, embodiments herein can provide a unique presentation appropriate for each individual in the portion of the display 104 directly in front of where the individual is seated (and properly oriented toward the individual). Therefore, if multiple users are seated around the display 104 to have a meeting, each of the different documents the different users may have prepared for the meeting can be presented on the portion of the display where their personal item is located. By inferring each user's seat location from infrared-printed content maintained on the user's personal items (e.g., bottom of a coffee cup) each of the users would be displayed their own unique documents (or different versions of the same documents) in front of their seat location.

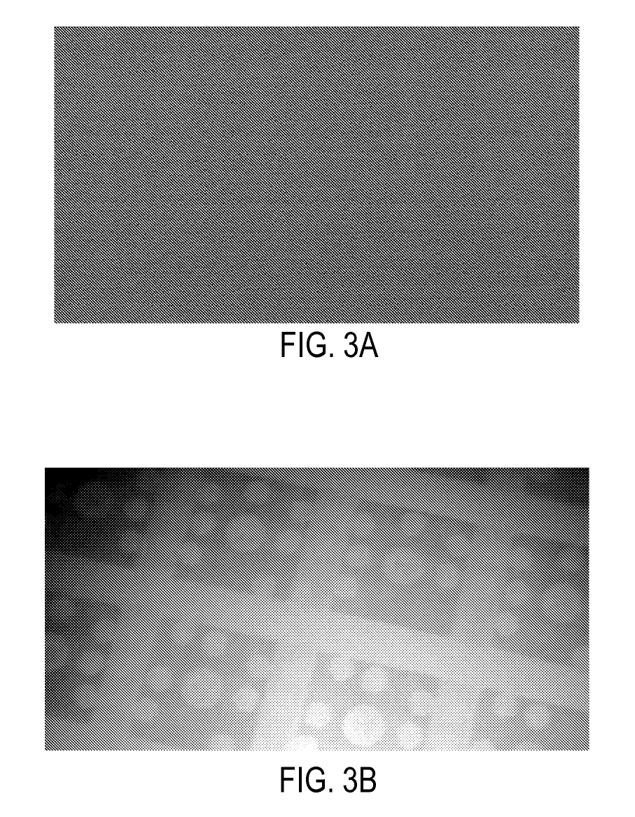

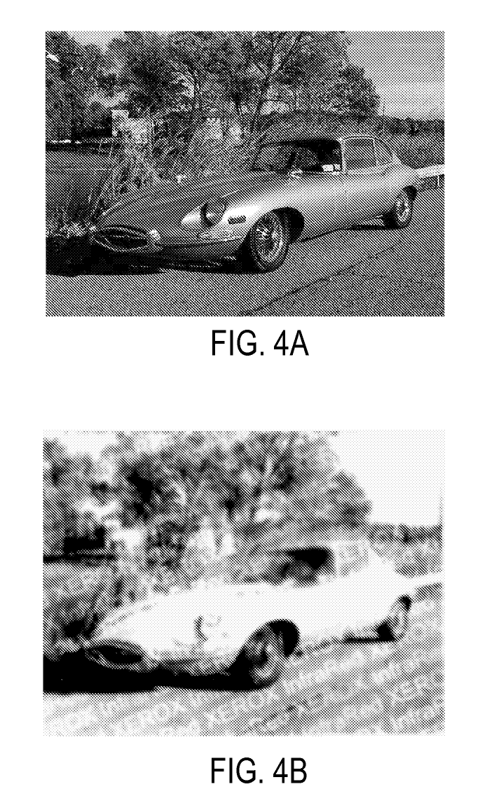

The infrared-printed content can comprise any form of identifier including plain text, numbers, barcodes, glyphs, etc. FIGS. 3A-4B illustrate some examples. FIG. 3A is a picture containing concealed infrared identifiers and FIG. 3B is the picture shown in FIG. 3A showing the concealed infrared identifiers. Similarly, FIG. 4A is a picture containing concealed infrared identifiers, and FIG. 4B is the picture shown in FIG. 3A showing the concealed infrared identifiers.

Thus, with embodiments herein, once an item is in position, the item may be recognized by the social computing device and represented digitally, using the concealed infrared identifiers (infrared code). Thus, the concealed identifier(s) may be used to control the device display and other operations supported by the device. In the simplest case the concealed identifier(s) may permit access to the device and its display, but more generally, complex operations can be associated with presentation of the identifiers, so that the device can be controlled through their use. This especially useful because such devices may choose not to use traditional computer keyboards, complicating more well-known ways of controlling devices. The concealed identifiers may also intentionally interact with marks that the user may make on the object, say a document, using, say, a graphite pencil, which leaves marks that are infrared visible.

In the case of a printed document, the device may recognize document metadata printed in infrared markings on the document and use that to retrieve a digital version of the document from a repository. Then, as shown above, the embodiments herein can display a representation of the document so that the electronic representation related to the item can be manipulated by the users of the device. Similarly, other objects may be represented digitally and manipulated using the input mechanisms of the social computing device, e.g. hand gestures and the like, using the same technique of recognizing metadata identifiers embedded on or within the object. Thus a cell phone, book, coffee mug, secure access badge, tourist memento of the Eiffel Tower or other item can appear to pass in this way from the physical realm to the digital realm, by means of the social computing device.

The enhancements provided by the embodiments herein can substantially improve user interaction and user enjoyment levels. For example, some users maintain duplicates of pictures, music, documents, etc. on a network accessible computer and on portable computing devices (such as a portable camera, PDA, cell phone, and MP 3 player, etc). If such a user places a portable computing device containing a printed infrared code on the display of 104, the embodiments herein retrieve the pictures, music, documents, etc. maintained within the portable computing device from the network accessible computer. This allows all the users of the interface social computing device 102 to listen to or view the pictures, music, documents, etc. maintained within the portable computing device without having to download items from the portable computing device to the interface device 102.

Similarly, authors of documents or book publishers can print infrared codes on the documents or books and make a copy of the document or book available on a network accessible computer. Then, when a user of an interface social computing device 102 places the document or book on the display 104, the interface social computing device 102 can display multiple copies of the document or book to each of the users of the interface social computing device 102, properly oriented to each user. This relieves the users of the interface device from having to download the document or book to the interface device 102 manually.

One feature of the embodiments herein is that the same cameras that are used to detect user input are also be used to detect concealed infrared object metadata identifiers. There are many advantages to concealing identifiers and printing them as infrared codes, as described above. For example, it is harder to tamper with such identifiers without special infrared equipment. Further, because such infrared codes cannot be observed by humans (without the aid of other devices) such markings are aesthetically more attractive, especially when incorporated within objects which rely on the preservation of an illusion or evocation which would be disturbed by the intrusion of metadata (e.g. a tourist memento in the form of a sculpture or model of a physical attraction such as the Eiffel Tower, the Mona Lisa, the Rock of Gibraltar, and the like.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The word “printer” or “image output terminal” as used herein encompasses any apparatus, such as a digital copier, bookmaking machine, facsimile machine, multi-function machine, etc. which performs a print outputting function for any purpose. The details of printers, printing engines, etc. are well known by those ordinarily skilled in the art and are discussed in, for example, U.S. Patent Publication Number 2008/0302263, the complete disclosure of which is fully incorporated herein by reference. The embodiments herein can encompass embodiments that print in color, monochrome, or handle color or monochrome image data. All foregoing embodiments are specifically applicable to electrostatic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims. The claims can encompass embodiments in hardware, software, and/or a combination thereof. Unless specifically defined in a specific claim itself, steps or components of the embodiments herein should not be implied or imported from any above example as limitations to any particular order, number, position, size, shape, angle, color, or material.

What is claimed is:

1. A machine-implemented method comprising:
receiving, by a processor, infrared inputs from at least one sensor when an item is placed upon a user interface detectable by said sensor, said processor being operatively connected to said user interface;
evaluating, by said processor, said infrared inputs to identify an infrared-printed content printed on said item;
retrieving, by said processor, an electronic representation related to said item from at least one computer storage device based on said infrared-printed content; and
displaying, by said processor, said electronic representation related to said item on said user interface.

2. The method according to claim 1, said infrared-printed content identifying the name of said item and a computer storage device location of said electronic representation related to said item.

3. The method according to claim 1, said infrared-printed content being detectable only by devices capable of reading light within the infrared portion of the electromagnetic spectrum.

4. The method according to claim 1, said item comprising a physical item capable of being manipulated by a user.

5. The method according to claim 1, said processor and said sensor comprising part of a social computing device capable of being operated simultaneously by multiple users.

6. A machine-implemented method comprising:
printing, by an infrared printer, infrared code on an item;
detecting, by a sensor, said infrared code on said item when said item is placed upon a user interface positioned within a detectable range of said sensor;
receiving, by a processor, infrared inputs from said sensor, said processor being operatively connected to said infrared printer, said sensor, and said user interface;
evaluating, by said processor, said infrared inputs to identify said infrared-printed content printed on said item;
retrieving, by said processor, an electronic representation related to said item from at least one computer storage device based on said infrared-printed content; and
displaying, by said processor, said electronic representation related to said item on said user interface.

7. The method according to claim 6, said infrared-printed content identifying the name of said item and a computer storage device location of said electronic representation related to said item.

8. The method according to claim 6, said infrared-printed content being detectable only by devices capable of reading light within the infrared portion of the electromagnetic spectrum.

9. The method according to claim 6, said item comprising a physical item capable of being manipulated by a user.

10. The method according to claim 6, said processor and said sensor comprising part of a social computing device capable of being operated simultaneously by multiple users.

11. A social computing device comprising:
a user interface comprising a display;
a processor operatively connected to said user interface;
a sensor operatively connected to said processor and being positioned to sense items on said interface; and
a computer storage device operatively connected to said processor,
said processor receiving infrared inputs from said sensor when an item is placed upon said user interface;
said processor evaluating said infrared inputs to identify an infrared-printed content printed on said item;
said processor retrieving an electronic representation related to said item from said computer storage device based on said infrared-printed content; and
said processor displaying said electronic representation related to said item on said user interface.

12. The social computing device according to claim 11, said infrared-printed content identifying the name of said item and a computer storage device location of said electronic representation related to said item.

13. The social computing device according to claim 11, said infrared-printed content being detectable only by devices capable of reading light within the infrared portion of the electromagnetic spectrum.

14. The social computing device according to claim 11, said item comprising a physical item capable of being manipulated by a user.

15. The social computing device according to claim 11, said social computing device being capable of being operated simultaneously by multiple users.

16. A system comprising:
a user interface comprising a display;
a processor operatively connected to said user interface;
a sensor operatively connected to said processor and being positioned to sense items physically on said interface;
a computer storage device operatively connected to said processor; and
an infrared printer operatively connected to said processor,
said processor storing, within said computer storage device, identifications of items as infrared-printed contents are printed on said items by said infrared printer,
said processor receiving infrared inputs from said sensor when an item having one of said infrared-printed contents is placed upon said user interface,
said processor evaluating said infrared inputs to identify an infrared-printed content printed on said item,
said processor retrieving an electronic representation related to said item from said computer storage device based on said infrared-printed content, and
said processor displaying said electronic representation related to said item on said user interface.

17. The system according to claim 16, said infrared-printed content identifying the name of said item and a computer storage device location of said electronic representation related to said item.

18. The system according to claim 16, said infrared-printed content being detectable only by devices capable of reading light within the infrared portion of the electromagnetic spectrum.

19. The system according to claim 16, said item comprising a physical item capable of being manipulated by a user.

20. The system according to claim 16, said infrared printer comprising one of an electrostatic printer and xerographic printer.
